(19) United States
(12) Patent Application Publication
(10) Pub. No.: US 2011/0280400 A1
(43) Pub. Date: Nov. 17, 2011

(54) CLOUD STORAGE SYSTEM AND METHOD

(75) Inventor: Che-Min Chung, Taipei (TW)

(73) Assignee: CHUNGHWA TELECOM CO., LTD., Taipei (TW)

(21) Appl. No.: 12/915,326

(22) Filed: Oct. 29, 2010

(30) Foreign Application Priority Data
May 14, 2010 (TW) 099115396

(51) Int. Cl. G06F 21/20; H04K 1/00; G06F 15/16

(52) U.S. Cl. 380/262; 726/6

(57) ABSTRACT

A cloud storage method includes: connecting a portable electronic device having a hardware identification code to a mediation device; generating a first verification serial number by a first serial number generating module of the portable electronic device via the hardware identification code and transmitting the first verification serial number to a cloud server via the mediation device and a network system connecting to the mediation device and the cloud server; generating a second verification serial number by a second serial number generating module of the cloud server having a storage module via a hardware identification code pre-stored in the storage module; and a comparison module built in the cloud server comparing the first and second verification serial numbers so as to process the storage module according to an operating signal sent by the user when the first and second verification serial numbers are determined to be the same.

### BACKGROUND OF THE INVENTION

1. Field of the Invention

The present invention generally relates to cloud storage systems and methods, and, more particularly, to a cloud storage system and method with a portable electronic device capable of generating a verification serial number connected to a cloud server through a network system.

2. Description of Related Art

Electronic storage products such as floppy disks, hard disks and CD-ROMs have been widely used by the public to store digital files or video images. Compact flash drives are portable and easy to use and are more advanced storage solutions.

But such flash drives are easily lost or stolen, which poses a significant risk of data loss and unauthorized usage. Accordingly, some flash drives use fingerprint and/or password recognition to improve data security, which, however, greatly reduces the usage flexibility of flash drives and is unable to completely avoid unauthorized use of data.

Further, despite increasing storage density, in order to save and carry a relatively large amount of data, the user often needs to divide the data into several parts so as to be stored in different flash drives, which causes a lot of trouble for the user organizing the data and utilizing multiple devices. Furthermore, the lifetime of the flash drives can be adversely affected by environmental factors such as vibration and humidity and other factors such as usage frequency, thereby easily causing damage to the data stored in the flash drives. Accordingly, the user cannot rely on the flash drives to store important data.

Therefore, it is imperative to provide a cloud storage system applied in a network system so as to facilitate the user to conveniently and safely store data and overcome the conventional drawbacks of data loss and unauthorized usage.

### SUMMARY OF THE INVENTION

In view of the above drawbacks of the prior art, the present invention provides a cloud storage system applicable to a network system, which comprises: a portable electronic device having a hardware identification code, comprising a first serial number generating module for operating on the hardware identification code according to a preset algorithm so as to generate a first verification serial number, and a first connection interface for transmitting the first verification serial number; a mediation device, comprising an operating module operable by a user so as to send an operating signal, a second connection interface connected with the first connection interface so as to receive the first verification serial number from the first connection interface, and a first connecting module connected with the network system for transmitting the first verification serial number received by the second connection interface and the operating signal sent from the operating module; and a cloud server comprising a storage module for storing a pre-input hardware identification code and/or data, a second connecting module connected with the network system for receiving the first verification serial number and the operating signal transmitted from the first connecting module, a second serial number generating module for operating on the hardware identification code stored in the storage module according to the preset algorithm so as to generate a second verification serial number, and a comparison module for comparing the first verification serial number received by the second connecting module and the second verification serial number generated by the second serial number generating module so as to process the data stored in the storage module according to the operating signal received by the second connecting module when the first and second verification serial numbers are determined to be the same.

In an embodiment, the portable electronic device further comprises a first time stamp generating module for generating a time stamp based on time, and the first serial number generating module employs the preset algorithm to operate on the hardware identification code of the portable electronic device and the time stamp generated by the first time stamp generating module, so as to generate the first verification serial number. In another embodiment, the cloud server further comprises a second time stamp generating module for generating a time stamp based on time, and the second serial number generating module employs the preset algorithm to operate on the hardware identification code stored in the storage module and the time stamp generated by the second time stamp generating module, so as to generate the second verification serial number.

The present invention further provides a cloud storage method applicable to the cloud storage system of the present invention. The cloud storage method comprises the steps of: connecting the first connection interface with the second connection interface; having the first serial number generating module to operate on the hardware identification code of the portable electronic device according to the preset algorithm so as to generate the first verification serial number; transmitting by the first connection interface the first verification serial number to the second connection interface; transmitting by the first connecting module the first verification serial number received by the second connection interface through the network system to the second connecting module; having the second serial number generating module operate on the hardware identification code stored in the storage module according to the preset algorithm so as to generate the second verification serial number; having the comparison module compare the first verification serial number and the second verification serial number, wherein, if the first and second verification serial numbers are determined to be the same, the comparison module processes the storage module according to the operating signal received by the second connecting module, and, otherwise, the process is ended.

In an embodiment, the portable electronic device further comprises a first time stamp generating module for generating a time stamp based on time, and the method further comprises the step of generating a time stamp by the first time stamp generating module such that the first serial number generating module operates on the hardware identification code of the portable electronic device and the time stamp generated by the first time stamp generating module according to the preset algorithm so as to generate the first verification serial number. In another embodiment, the cloud server further comprises a second time stamp generating module for generating a time stamp based on time, and the method further comprises the step of generating a time stamp by the second time stamp generating module such that the second serial number generating module operates on the hardware identification code stored in the storage module and the time stamp generated by the second time stamp generating module according to the preset algorithm so as to generate the second verification serial number.

According to the present invention, the portable electronic device is connected to the mediation device so as to generate a first verification serial number and transmit it to the cloud server, and then a second verification serial number is generated by the cloud server and compared to the first verification serial number such that the storage module of the cloud server can be processed according to operating signals sent by the user when the first and second verification serial numbers are determined to be the same. Thereby, the present invention provides a safe and convenient storage system and method, avoids the conventional drawbacks of data loss and unauthorized usage and further prevents insufficient storage capacity that causes a lot of trouble to the user.

### BRIEF DESCRIPTION OF DRAWINGS

FIG. 1 is a block diagram showing the structure of a cloud storage system according to a first embodiment of the present invention;

FIG. 2 is a block diagram showing the structure of a cloud storage system according to a second embodiment of the present invention;

FIG. 3 is a block diagram showing the structure of a cloud storage system according to a third embodiment of the present invention; and

FIG. 4 is a flowchart showing a cloud storage method according to the first embodiment of the present invention.

### DETAILED DESCRIPTION OF PREFERRED EMBODIMENTS

The following illustrative embodiments are provided to illustrate the disclosure of the present invention and its advantages, these and other advantages and effects being apparent to those in the art after reading this specification.

### First Embodiment

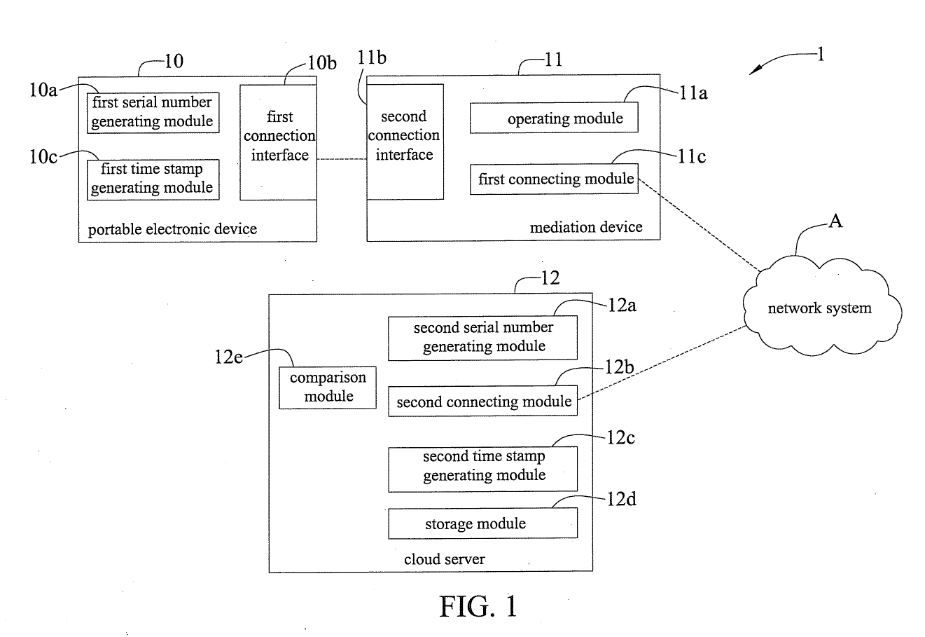

FIG. 1 is a block diagram showing the structure of a cloud storage system 1 according to a first embodiment of the present invention. Referring to FIG. 1, the cloud storage system 1 comprises a portable electronic device 10, a mediation device 11 and a cloud server 12.

The portable electronic device 10 has an embedded unique hardware identification code (not shown). The portable electronic device 10 can optionally comprise: a first time stamp generating module 10c for generating a time stamp based on time; a first serial number generating module 10a for operating on the hardware identification code and the time stamp according to a preset algorithm so as to generate a first verification serial number; and a first connection interface 10b for transmitting the first verification serial number.

In the present embodiment, the hardware identification code can be a serial number set by the manufacturer. The first serial number generating module 10a and the first time stamp generating module 10c can be, for example, software programs with a logic operating function and stored in a memory chip (not shown) of the portable electronic device 10. The preset algorithm can be a secure hash algorithm stored in the memory chip, for example, SHA-1, SHA-2, SHA-224, SHA-256, SHA-384 and/or SHA-512. The first connection interface 10b can be, for example, a universal serial bus (USB) interface.

The mediation device 11 comprises an operating module 11a operable by a user to send an operating signal, a second connection interface 11b connected with the first connection interface 10b for receiving the first verification serial number transmitted from the first connection interface 10b, and a first connecting module 11c connected with a network system A so as to transmit the first verification serial number received by the second connection interface 11b and the operating signal sent from the operating module 11a.

In the present embodiment, the mediation device 11 can be, for example, a personal computer or a notebook computer. The operating module 11a can be, for example, a mouse and/or a touch screen. The second connection interface 11b can be an interface corresponding to the first connection interface 10b, for example, a USB socket. The first connecting module 11c can be, for example, a wireless/wired network card or an antenna capable of sending and receiving information. The network system A can be an Ethernet system, a GSM network system, a 3G network system, a WiMAX network system or a Wi-Fly network system.

The cloud server 12 can be disposed on a backbone network system. The cloud server 12 comprises a storage module 12d for storing a pre-input hardware identification code and data (e.g. data in different formats, such as video, sound and text), and a second connecting module 12b connected with the network system A for receiving the first verification serial number and the operating signal transmitted from the first connecting module 11c. Preferably, the cloud server 12 can optionally comprise: a second time stamp generating module 12c for generating a time stamp based on time; a second serial number generating module 12a for operating on the hardware identification code stored in the storage module 12d and the time stamp generated by the second time stamp generating module 12c according to the above-described preset algorithm so as to generate a second verification serial number; and a comparison module 12e for comparing the first verification serial number received by the second connecting module 12b and the second verification serial number generated by the second serial number generating module 12a so as to process the storage module 12d according to the operating signal received by the second connecting module 12b when the first and second verification serial numbers are determined to be the same.

In the present embodiment, the storage module 12d can be a hard disk array with large storage capacity. The second serial number generating module 12a and the second time stamp generating module 12c can be modules such as software programs with a logic operating functions stored in a memory (not shown) of the cloud server 12. The second connecting module 12b can be, for example, a wireless/wired network card or an antenna capable of sending and receiving information. The hardware identification code stored in the storage module 12d is the hardware identification code of the portable electronic device 10 that is pre-stored in the storage module 12d when the portable electronic device 10 is sold to the user. In other embodiments, the hardware identification code can be a code such as a media access control (MAC) code. Lastly, the comparison module 12e can be, for example, an intelligent processor having logic comparison, operating and processing functions.

Therefore, in practice, the first connection interface 10b is connected to the second connection interface 11b and, meanwhile, the first time stamp generating module 10c generates a time stamp such that the first serial number generating module 10a uses the hardware identification code of the portable electronic device 10 and the time stamp generated by the first time stamp generating module 10c to generate a first verification serial number. The first verification serial number is further transmitted to the cloud server 12 through the first connecting module 11c, the network system A and the second connecting module 12b. Meanwhile, the second time stamp generating module 12c generates a time stamp such that the second serial number generating module 12a uses the time stamp generated by the second time stamp generating module 12c and the hardware identification code pre-stored in the storage module 12d to generate a second verification number. Next, the comparison module 12e compares the first verification serial number and the second verification serial number so as to process (e.g. edit, download or browse) the data stored in the storage module 12d according to the operating signal received by the second connecting module 12b when the first and second verification numbers are determined to be the same.

Generally, the first and second time stamp generating modules 10c and 12c generate the same time stamp at the same time. For example, at the time of 10:10, both the first and second time stamp generating modules 10c and 12c generate a time stamp of 1010. Based on the same algorithm, time stamp and hardware identification code, the second verification serial number generated by the second serial number generating module 12a is the same as the first verification serial number generated by the first serial number generating module 10a. Thereby, the comparison module 12e identifies the user so as to process the data stored in the storage module 12d according to the operating signal sent from the operating module 11a of the mediation device 11.

It should be noted that, in other embodiments, the portable electronic device 10 and the cloud server 12 can be provided without the first time stamp generating module 10c and the second time stamp generating module 12c, respectively. Meanwhile, the first and second serial number generating modules 10a, 10b can only operate on the hardware identification code of the portable electronic device 10 and the hardware identification code pre-stored in the storage module 12d so as to generate the first verification serial number and the second verification serial number, respectively. Therein, the first verification serial number is transmitted to the cloud server 12 through the first connection interface 10b, the second connection interface 11b, the first connecting module 11c, the network system A and the second connecting module 12b in sequence.

Further, the cloud server 12 can optionally comprise an anti-virus module (not shown). When the comparison module 12e determines that the first and second verification serial numbers are the same, the comparison module 12e allows the anti-virus module to scan the content of the storage module 12d so as to detect, remove and/or isolate viruses, thereby protecting the user against the viruses and improving data safety.

### Second Embodiment

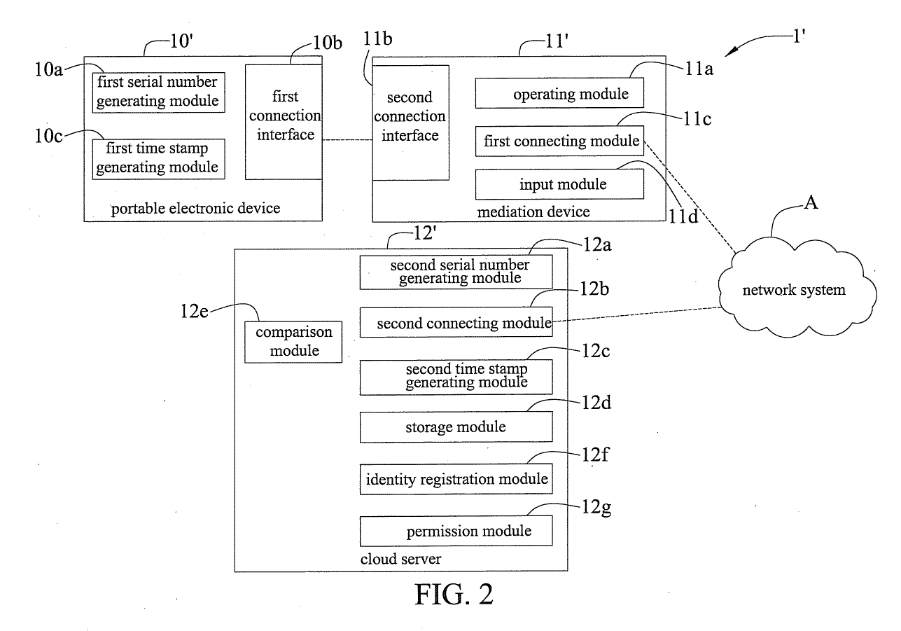

FIG. 2 is a block diagram showing the structure of a cloud storage system 1′ according to a second embodiment of the present invention. Referring to FIG. 2, the cloud storage system 1′ comprises a portable electronic device 10′, a mediation device 11′ and a cloud server 12′.

The difference between the cloud storage system 1′ from the cloud storage system 1 is that the mediation device 11′ further comprises an input module 11d, and the cloud server 12′ further comprises an identity registration module 12f and a permission module 12g.

The input module 11d, such as a keyboard or a touch panel, allows the user to input his/her identity data and a permission instruction. The first connecting module 11c further transmits the input identity data and permission instruction to the second connecting module 12b through the network system A. The identity registration module 12f allows the user to pre-register his/her identity data in the storage module 12d according to the hardware identification code of the portable electronic device 10′. For example, the identity data can be a number associated with a natural person and/or an account number of the user who purchases the portable electronic device 10′. The identity registration module 12f can be a web interface that allows the user who purchases the portable electronic device 10′ to register his/her identity data. The hardware identification code and the corresponding identity data can be selectively stored in the storage module 12d.

The permission module 12g is used to enable/disable permission to operate the storage module 12d according to the above-described permission instruction. In particular, when the second connecting module 12b receives the identity data and permission instruction from the input module 11d, the comparison module 12e compares the identity data received by the second connecting module 12b and the identity data pre-registered in the storage module 12d, and, if the identity data are determined to be the same, the comparison module 12b allows the permission module 12g to enable/disable the permission to process the storage module 12d according to the permission instruction received by the second connecting module 12b.

For example, after purchasing the portable electronic device 10′, the user registers his/her identity data in the storage module 12d through the identity registration module 12f of the cloud server 12′. If the portable electronic device 10′ is later lost, the user can input his/her identity data and a permission disable instruction through the input module 11d to the cloud server 12. Once the comparison module 12 determines that the identity data are the same, it allows the permission module 12g to disable the permission to use the storage module 12d so as to prevent others that find the portable electronic device 10′ from entering into the cloud server 12′ and processing the data stored in the storage module 12, thereby avoiding the risk of data being compromised. On the other hand, when the user gets back the portable electronic device 10′, the user can input a permission enable instruction through the input module 11d so as to enable permission to process data in the storage module 12d.

### Third Embodiment

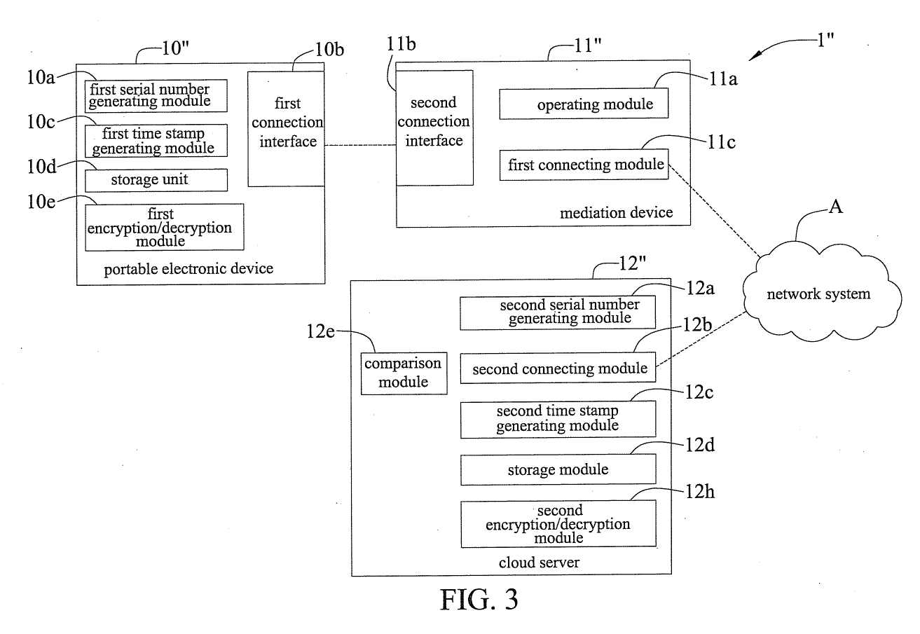

FIG. 3 is a block diagram showing the structure of a cloud storage system 1″ according to a third embodiment of the present invention. Referring to FIG. 3, the cloud storage system 1″ comprises a portable electronic device 10″, a mediation device 11″ and a cloud server 12″.

The difference between the cloud storage system 1″ from the cloud storage system 1 is that the portable electronic device 10″ further comprises a storage unit 10d and a first encryption/decryption module 10e, and the cloud server 12″ further comprises a second encryption/decryption module 12h.

The storage unit 10d can be a unit such as a volatile or non-volatile memory. Therefore, according to operating signals received by the second connecting module 12b through the network A, the comparison module 12e can at least perform content exchange, duplication and transferring processes to the data stored in the storage module 12d and the storage unit 10d.

When the comparison module 12e performs the above-described processes to the storage module 12d and the storage unit 10d, the first encryption/decryption module 10e and the second encryption/decryption module 12h can symmetrically encrypt and decrypt the content of the storage module 12d and the storage unit 10d, thereby efficiently preventing the content from being stolen during transmission, improving the transmission security and avoiding the risk of data being compromised. In the present embodiment, the first encryption/decryption module 10e and the second encryption/decryption module 12h can encrypt and decrypt the transmitted content according to the first verification serial number generated by the first serial number generating module 10a and the second verification serial number generated by the second serial generating module 12a, respectively.

In the present embodiment, the cloud server 12″ can optionally comprise an anti-virus module (not shown). When the comparison module 12e determines that the first and second verification serial numbers are the same, the comparison module 12e allows the anti-virus module to scan the content of the storage module 12d and the storage unit 10d so as to detect, remove and/or isolate viruses, thereby preventing the spread of virus-infected data.

Further, the cloud storage systems 1, 1′ and 1″ of the first to third embodiments can be integrated according to customized requirements. That is, for example, the portable device 10 can optionally comprise the storage unit 10d and the first encryption/decryption module 10e; the mediation device 11 can optionally comprise the input module 11d; and the cloud server 12 can optionally comprise the identity registration module 12f, the permission module 12g and the second encryption/decryption module 12h.

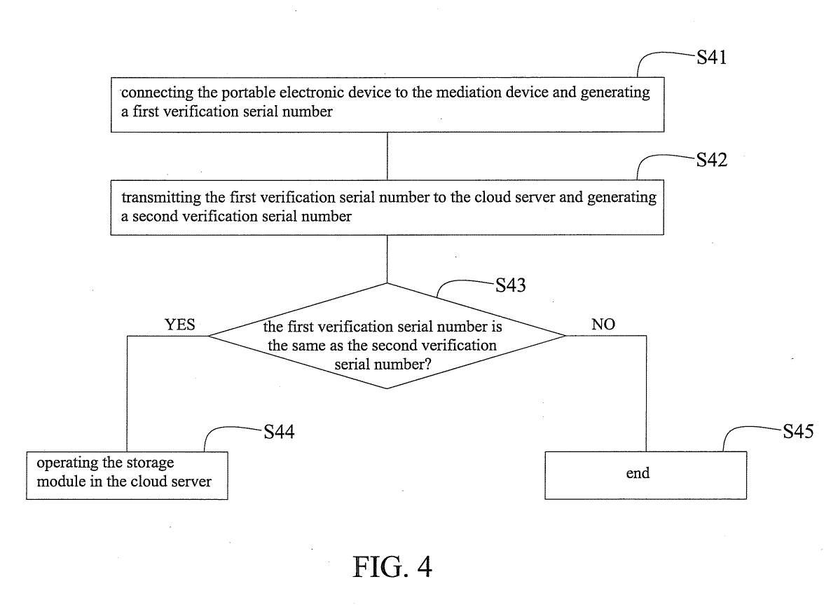

FIG. 4 is a flowchart showing a cloud storage method according to the first embodiment of the present invention.

At step S41, the first connection interface 10b is connected with the second connection interface 11b so that the first serial number generating module 10a generates a first verification serial number according to a preset algorithm, and the first connection interface 10b transmits the first verification serial number to the second connection interface 11b. Then, the method goes to step S42.

In the present embodiment, the portable electronic device 10 allows the first time stamp generating module 10c to generate a time stamp such that the first serial number generating module 10a generates the first verification serial number based on the time stamp and the hardware identification code of the portable electronic device 10. On the other hand, if the portable electronic device 10 does not comprise the first time stamp generating module 10c, the first serial number generating module 10a can generate the first verification serial number only based on the hardware identification code of the portable electronic device 10.

At step S42, the first connecting module 11c transmits the first verification serial number received by the second connection interface 11b through the network system A to the second connecting module 12b, and the second serial number generating module 12a operates on the hardware identification code pre-stored in the storage module 12d according to the preset algorithm so as to generate a second verification serial number. Then, the method goes to step S43.

In the present embodiment, the cloud server 12 can allow the second time stamp generating module 12c to generate a time stamp such that the second serial number generating module 12a can generate the second verification serial number based on the time stamp and the pre-stored hardware identification code. On the other hand, if the portable electronic device 10 does not comprise the first time stamp generating module 10c, the cloud server 12 does not need to comprise the second time stamp generating module 12c. In such case, the second serial number generating module 12a can generate the second verification serial number only based on the pre-stored hardware identification code.

At step S43, the comparison module 12e compares the first verification serial number and the second verification serial number to determine whether the first and second verification serial numbers are the same, wherein, if they are, the method goes to step S44, or, otherwise, the method goes to step S45 so as to end the cloud storage method of the present invention.

At step S44, the comparison module 12e processes (e.g. edits, browses or downloads) the data stored in the storage module 12d according to the operating signal received by the second connecting module 12b.

In other embodiments, if the portable electronic device 10 of the cloud storage system 1 further comprises the storage unit 10d as shown in FIG. 3, the comparison module 12e can at least perform content exchange, duplication and transfer processes on the data stored in the storage unit 10d and the storage module 12d.

In other embodiments, if the portable electronic device 10 of the cloud storage system 1 comprises the first encryption/decryption module 10e as shown in FIG. 3 and the cloud server 12 of the cloud storage system 1 comprises the second encryption/decryption module 12h of FIG. 3, at step S44, the comparison module 12e allows the first encryption/decryption module 10e and the second encryption/decryption module 12h to symmetrically encrypt and decrypt the content of the storage unit 10d and the storage module 12d.

Further, in other embodiments, if the cloud server 12 of the cloud storage system 1 further comprises the above-described anti-virus module, at step S44, the comparison module 12e allows the anti-virus module to scan the content of the storage module 12d and/or the storage unit 10d so as to detect, remove and/or isolate viruses.

According to the present invention, the portable electronic device is connected to the mediation device so as to generate a first verification serial number and transmit it to the cloud server, and then a second verification serial number is generated by the cloud server and compared to the first verification serial number such that the storage module of the cloud server can be processed according to operating signals sent by the user when the first and second verification serial numbers are determined to be the same. Thereby, the present invention provides a safe and convenient storage system and method, avoids the conventional drawbacks of data loss and unauthorized usage and further prevents insufficient storage capacity that can cause difficulty for the user.

The above-described descriptions of the detailed embodiments are provided to illustrate the preferred implementation according to the present invention, and are not intended to limit the scope of the present invention. Accordingly, many modifications and variations can be made by those with ordinary skill in the art and yet still fall within the scope of present invention as defined by the appended claims.

What is claimed is:

1. A cloud storage system applicable to a network system, comprising:
a portable electronic device having a hardware identification code, comprising:
a first serial number generating module for operating on the hardware identification code according to a preset algorithm so as to generate a first verification serial number; and
a first connection interface for transmitting the first verification serial number;
a mediation device, comprising:
an operating module operable by a user so as to send an operating signal;
a second connection interface connected with the first connection interface so as to receive the first verification serial number transmitted from the first connection interface; and
a first connecting module connected with the network system for transmitting the first verification serial number received by the second connection interface and the operating signal sent from the operating module; and
a cloud server, comprising:
a storage module for storing a pre-input hardware identification code and/or data;
a second connecting module connected with the network system for receiving the first verification serial number and the operating signal transmitted from the first connecting module;
a second serial number generating module for operating on the hardware identification code stored in the storage module according to the preset algorithm so as to generate a second verification serial number; and
a comparison module for comparing the first verification serial number received by the second connecting module and the second verification serial number generated by the second serial number generating module so as to process the data stored in the storage module according to the operating signal received by the second connecting module when the first and second verification serial numbers are determined to be the same.

2. The system of claim 1, wherein the cloud server further comprises an identity registration module that allows the user to register in the storage module identity data corresponding to the hardware identification code of the portable electronic device.

3. The system of claim 2, wherein the mediation device further comprises an input module that allows the user to input his/her identity data and a permission instruction, and the first connecting module further transmits the input identity data and permission instruction through the network system to the second connecting module.

4. The system of claim 3, wherein the cloud server further comprises a permission module for enabling/disabling permission to operate the storage module, the comparison module further compares the identity data received by the second connecting module and the identity data registered in the storage module and, when the identity data are determined to be the same, the comparison module allows the permission module to enable/disable the permission to operate the storage module according to the permission instruction received by the second connecting module.

5. The system of claim 1, wherein the portable electronic device further comprises a first time stamp generating module for generating a time stamp based on time, and the first serial number generating module employs the preset algorithm to operate on the hardware identification code of the portable electronic device and the time stamp generated by the first time stamp generating module, so as to generate the first verification serial number.

6. The system of claim 1, wherein the cloud server further comprises a second time stamp generating module for generating a time stamp based on time, and the second serial number generating module employs the preset algorithm to operate on the hardware identification code stored in the storage module and the time stamp generated by the second time stamp generating module, so as to generate the second verification serial number.

7. The system of claim 1, wherein the preset algorithm is a secure hash algorithm.

8. The system of claim 1, wherein the portable electronic device further comprises a storage unit, and the comparison module at least performs content exchange, duplication and transfer processes among the storage module and the storage unit according to the operating signal received by the second connecting module.

9. The system of claim 8, wherein the portable electronic device further comprises a first encryption/decryption module, and the cloud server further comprises a second encryption/decryption module, the first and second encryption/decryption modules symmetrically encrypting/decrypting content of the storage module and the storage unit when the comparison module performs the content exchange, duplication and transfer processes among the storage module and the storage unit.

10. The system of claim 9, wherein the first and second encryption/decryption modules symmetrically perform the encryption and decryption processes according to the first and second verification serial numbers, respectively.

11. The system of claim 8, wherein the cloud server further comprises an anti-virus module, such that, when the comparison module determines that the first and second verification serial numbers are the same, the comparison module allows the anti-virus module to scan the content of the storage module and the storage unit so as to detect, remove and/or isolate viruses according to the operating signal received by the second connecting module.

12. The system of claim 1, wherein the cloud server further comprises an anti-virus module, such that, when the comparison module determines that the first and second verification serial numbers are the same, the comparison module allows the anti-virus module to scan content of the storage module so as to detect, remove and/or isolate viruses according to the operating signal received by the second connecting module.

13. A cloud storage method applicable to the cloud storage system of claim 1, the method comprising the steps of:
(1) connecting the first connection interface with the second connection interface;
(2) having the first serial number generating module operate on the hardware identification code of the portable electronic device according to the preset algorithm so as to generate the first verification serial number;
(3) transmitting by the first connection interface the first verification serial number to the second connection interface;
(4) transmitting by the first connecting module the first verification serial number received by the second connection interface through the network system to the second connecting module;
(5) having the second serial number generating module operate on the hardware identification code stored in the storage module according to the preset algorithm so as to generate the second verification serial number;
(6) having the comparison module compare the first verification serial number and the second verification serial number, wherein, if the first and second verification serial numbers are determined to be the same, the process proceeds to step (7), and, otherwise, the process is ended; and
(7) having the comparison module process the storage module according to the operating signal received by the second connecting module.

14. The method of claim 13, wherein the portable electronic device further comprises a first time stamp generating module for generating a time stamp based on time, and step (2) further comprises the step of generating a time stamp by the first time stamp generating module.

15. The method of claim 14, wherein, at step (2), the first serial number generating module operates on the hardware identification code of the portable electronic device and the time stamp generated by the first time stamp generating module according to the preset algorithm so as to generate the first verification serial number.

16. The method of claim 13, wherein the cloud server further comprises a second time stamp generating module for generating a time stamp based on time, and step (5) further comprises the step of generating a time stamp by the second time stamp generating module.

17. The method of claim 16, wherein, at step (5), the second serial number generating module operates on the hardware identification code stored in the storage module and the time stamp generated by the second time stamp generating module according to the preset algorithm so as to generate the second verification serial number.

18. The method of claim 13, wherein the portable electronic device further comprises a storage unit, and, at step (7), the comparison module at least performs content exchange, duplication and transferring processes to the storage module and the storage unit according to the operating signal received by the second connecting module.

19. The method of claim 18, wherein the portable electronic device further comprises a first encryption/decryption module, and the cloud server further comprises a second encryption/decryption module, and, at step (7), the first and second encryption/decryption modules symmetrically encrypt/decrypt content of the storage module and the storage unit.

20. The method of claim 13, wherein the cloud server further comprises an anti-virus module, and, at step (7), the comparison module allows the anti-virus module to scan the storage module so as to detect, remove and/or isolate viruses according to the operating signal received by the second connecting module.
